(19) United States
(12) Patent Application Publication
(10) Pub. No.: US 2021/0036473 A1
(43) Pub. Date: Feb. 4, 2021

(54) ELECTRICAL RECEPTACLE

(71) Applicant: Keystone Automotive Operations, Inc., Wilsonville, OR (US)

(72) Inventors: Christopher Moore, Elkhart, IN (US); Eric Sharp, Beaverton, OR (US); Steven J. Paventy, Sandy, OR (US); Chen Jui Lung, New Taipei City (TW); Xu Bo, Dongguan (CN); Rong Zhong Long, Dongguan (CN)

(73) Assignee: Keystone Automotive Operations, Inc., Wilsonville, OR (US)

(21) Appl. No.: 16/529,701

(22) Filed: Aug. 1, 2019

(51) Int. Cl. H01R 24/76; H01R 13/66; H01R 13/453; H02G 3/08; H01R 13/639

(52) U.S. Cl. CPC H01R 24/76; H01R 13/6675; H01R 2103/00; H02G 3/08; H01R 13/6395; H01R 13/453

(57) ABSTRACT

The present disclosure is directed toward an electrical receptacle for installation in a wall adjacent an area allowing only a limited depth for the electrical receptacle, such as in recreational vehicles, for connection to an AC power source. The electrical receptacle may include a face cover defining an outer side and an inner side and a back enclosure defining a front edge and a rear edge. The face cover and the back enclosure may together define a receptacle depth, from the inner side of the face cover to the rear edge of the back enclosure, that is not greater than the limited depth. The electrical receptacle may provide a DC outlet and an AC outlet, with each outlet accessible adjacent the outer side of the face cover. The face cover and the back enclosure may define an internal volume and an electrical connector for connecting to an AC power source may be within the internal volume.

### FIELD OF THE DISCLOSURE

This disclosure relates to electrical receptacles configured for providing multiple types of outlets, for example, both AC and DC power outlets. More particularly, the disclosure relates to such receptacles for installation in a wall with limited depth behind the wall, for example, the more limited depth behind a wall in a recreational vehicle as compared to a residential housing construction.

### BACKGROUND OF THE DISCLOSURE

Providing an electrical receptacle that both works with household appliances and is installable in a recreational vehicle provides unique challenges. Ordinary household receptacles are too large to fit reliably in the shallower wall space available in recreational vehicles (RVs) as compared to the deeper wall space in residential housing and commercial construction. The different construction in RVs also places different requirements on the connectors for coupling to the RV power. However, users of RVs also expect to be able to plug in household appliances and other devices in the same manner as they would in a house or office, so the electrical outlets need to conform to those requirements at the same time. Currently existing electrical receptacles do not and cannot meet these simultaneous requirements.

For example, there are AC outlets, typically 120 volts for use in the US, for houses and commercial construction, which have been available for decades. Recently new versions of such receptacles also include a DC outlet, for example USB power connectors. However, these receptacles cannot be used in RVs due to space restrictions and code requirements for connectors. These receptacles, which typically include open or exposed connectors to the incoming power would be usable in an RV if installed in a junction box to protect the connections, but available junction boxes will not fit in RV walls.

A need exists for an electrical outlet providing both AC and DC power that has a smaller intrusion into the wall and has all wire connections contained within the structure, as opposed to being accessible on the outside of the structure. No currently available outlets provide these features.

### SUMMARY OF THE DISCLOSURE

The present disclosure is directed toward electrical receptacles for installation in a wall adjacent an area allowing only a limited depth for the electrical receptacle. The limited depth may be less than or equal to 44.45-mm or another depth that may be typical of a construction used in recreational vehicles. The electrical receptacle may be configured for connection to an AC power source and may include a face cover defining an outer side and an inner side.

The electrical receptacle may further include a back enclosure defining a front edge and a rear edge. The back enclosure may be configured to be coupled to the face cover with the front edge adjacent the inner side of the face cover. Together, the face cover and the back enclosure may define a receptacle depth from the inner side of the face cover to the rear edge of the back enclosure, wherein the receptacle depth is not greater than the limited depth. The electrical receptacle may further include a DC outlet and an AC outlet, with each outlet accessible adjacent the outer side of the face cover.

The electrical receptacle may further include an electrical connector for connecting to the AC power source and providing a connection to the AC outlet. The electrical receptacle may further include a DC power supply having an input connected to the AC power source and an output connected to the DC outlet.

The electrical receptacle may include the face cover and the back enclosure defining an internal volume wherein the electrical connector for connecting to the AC power source is within the internal volume. The AC power source may be provided via electrical wires wherein the electrical connector provides at least one quick-release fastener for connecting to the AC power source. The electrical receptacle may provide for the back enclosure including at least one hole allowing access to a control for at least one quick-release fastener. The electrical receptacle may further provide for the back enclosure including a bracket and a rear cover and the bracket may provide support for a printed circuit board providing at least a portion of the DC power supply.

Advantages of the present disclosure will be more readily understood after considering the Drawings and the Detailed Description.

### BRIEF DESCRIPTION OF THE DRAWINGS

FIG. 1 shows components of an electrical receptacle according to an embodiment of the present disclosure in a fully exploded view.

FIG. 2 shows the components of the electrical receptacle of FIG. 1 in a partially exploded view.

FIG. 3 shows a front view of the electrical receptacle of FIG. 1.

FIG. 4 shows a side view of the electrical receptacle of FIG. 1.

FIG. 5 shows an end view of the electrical receptacle of FIG. 1.

FIG. 6 shows a side view as in FIG. 4 with the receptacle installed in an area adjacent a wall.

FIG. 7 shows a rear view of the electrical receptacle of FIG. 1.

FIG. 8 is a block diagram of the components of the electrical receptacle of FIG. 1 for connecting to an AC power source and producing, through a DC power supply, DC power at outlets.

The drawings illustrate embodiments and schematic concepts for electrical receptacles according to the invention. The purpose of these drawings is to aid in explaining the principles of the invention. Thus, the drawings should not be considered as limiting the scope of the invention to the embodiments and schematic concepts shown therein. Other embodiments of electrical receptacles may be created which follow the principles of the invention as taught herein, and these other embodiments are intended to be included within the scope of patent protection.

### DETAILED DESCRIPTION OF THE DISCLOSURE

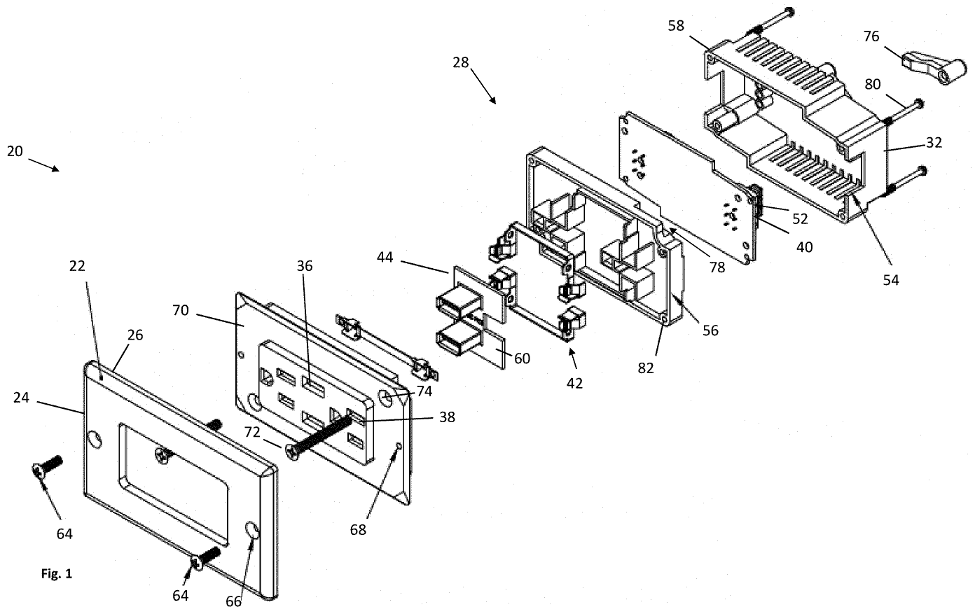

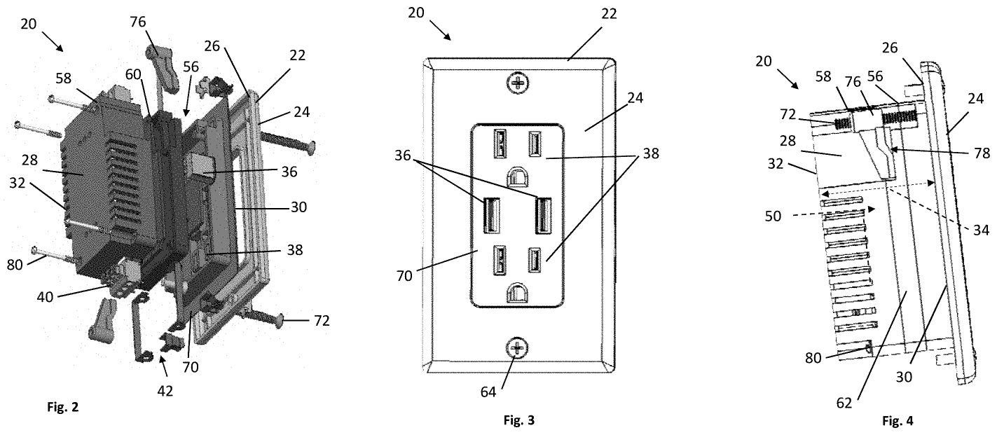

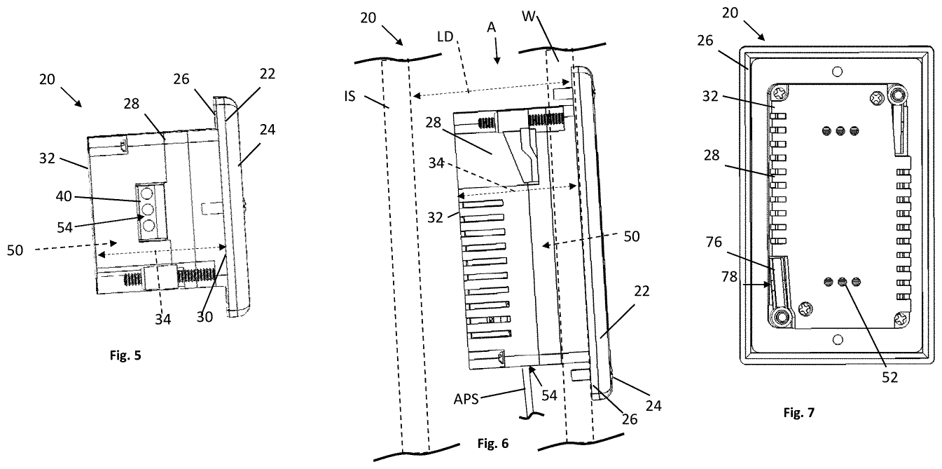

An example of an electrical receptacle 20 is shown in FIGS. 1-8. As seen in FIG. 5, electrical receptacle 20 may be configured for installation in a wall W adjacent an area A defined by wall W and an inner structure IS, which may allow only a limited depth LD for electrical receptacle 20. Limited depth LD may be defined by a typical depth of a construction used in recreational vehicles (RVs). Electrical receptacle 20 may be configured for connection to an AC power source APS.

Electrical receptacle 20 may include a face cover 22 defining an outer side 24 and an inner side 26. Electrical receptacle 20 may include a back enclosure 28 defining a front edge 30 and a rear edge 32. Back enclosure 28 may be configured to be coupled to face cover 22 with front edge 30 adjacent inner side 26 of face cover 22.

Face cover 22 and back enclosure 28 may together define a receptacle depth 34 from inner side 26 of face cover 22 to rear edge 32 of back enclosure 28. Typically, receptacle depth 34 is not greater than limited depth LD. For example, receptacle depth 34 may be not greater than 44.45-mm. Other typical sizes for receptacle depth 34 include not greater than 42-mm and not greater than 41.6-mm.

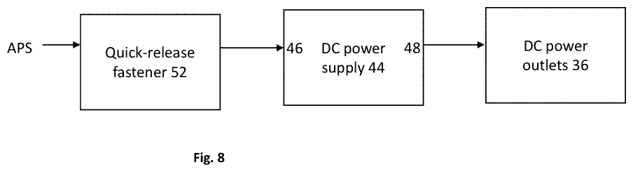

Electrical receptacle 20 may include a pair of DC outlets 36 and a pair of AC outlets 38. Each of outlets 36, 38 may be accessible adjacent outer side 24 of face cover 22. Electrical receptacle 20 may also include an electrical connector 40 for connecting to AC power source APS and providing a connection 42 to AC outlets 38. As best seen in FIGS. 1 and 8, electrical receptacle 20 may also include a DC power supply 44 having an input 46 connected to AC power source APS and an output 48 connected to DC outlets 36.

Electrical receptacle 20 may provide for face cover 22 and back enclosure 28 to define an internal volume 50. Electrical connector 40 for connecting to AC power source APS may be within internal volume 50. Electrical receptacle 20 may be used with AC power source APS wherein the AC power source is provided via electrical wires EW wherein electrical connector 40 provides at least one quick-release fastener 52 for connecting to AC power source APS. Electrical receptacle 20 may include, for example in back enclosure 28, at least one hole 54 allowing access to a control for the at least one quick-release fastener.

Back enclosure 28 may include a bracket 56 and a rear cover 58. Bracket 56 may provide support for a printed circuit board 60 providing at least a portion of DC power supply 44.

As described herein a combined power and USB outlet, such as electrical receptacle 20 may provide an integral enclosed box 62 with quick connect terminals 52 for coupling to an AC power input APS. Box 62 may be assembled to face cover 22 with fasteners, such as screws or bolts 64 at holes 66 in face cover 22. Box 62 may include holes 68 in a face plate 70 to receive screws or bolts 64.

Face plate 70 may provide DC outlets 36 and AC outlets 38. Box 62 may further be assembled by bolts 72 through holes 74 in face plate 70, which may couple face plate 70 to rear cover 58 by threading in wing nut 76 retained in a notch 78 in back enclosure 28. Rear cover 58 may additionally be secured with bracket 56 to box 62 by bolts 80 extending through holes 82 in bracket 56.

Electrical receptacle 20 may provide, as an example of DC and AC power outlets 36, 38, a combined USB & 120 volt duplex receptacle while simultaneously being designed and sized to fit in the walls of an RV. Additionally, electrical receptacle 20 will be understood to be easier to install, both at the OEM level and the aftermarket level. Installation of receptacle 20 may include mounting adjacent wall W with the use of bolts or screws 64 at one or more holes 66, 68 in

While embodiments of an electrical receptacle have been particularly shown and described, many variations may be made therein. This disclosure may include one or more independent or interdependent embodiments directed to various combinations of features, functions, elements and/or properties. Other combinations and sub-combinations of features, functions, elements and/or properties may be claimed later in a related application. Such variations, whether they are directed to different combinations or directed to the same combinations, whether different, broader, narrower or equal in scope, are also regarded as included within the subject matter of the present disclosure. Accordingly, the foregoing embodiments are illustrative, and no single feature or element, or combination thereof, is essential to all possible combinations that may be claimed in this or a later application.

It is believed that the disclosure set forth herein encompasses multiple distinct inventions with independent utility. While each of these inventions has been disclosed in its preferred form, the specific embodiments thereof as disclosed and illustrated herein are not to be considered in a limiting sense as numerous variations are possible. Each example defines an embodiment disclosed in the foregoing disclosure, but any one example does not necessarily encompass all features or combinations that may be eventually claimed. Where the description recites “a” or “a first” element or the equivalent thereof, such description includes one or more such elements, neither requiring nor excluding two or more such elements. Further, ordinal indicators, such as first, second or third, for identified elements are used to distinguish between the elements, and do not indicate a required or limited number of such elements, and do not indicate a particular position or order of such elements unless otherwise specifically stated.

What is claimed is:

1. An electrical receptacle for installation in a wall adjacent an area allowing only a limited depth for the electrical receptacle, wherein the limited depth may be defined by a typical depth of a construction used in recreational vehicles, the electrical receptacle configured for connection to an AC power source, the electrical receptacle comprising:
a. a face cover defining an outer side and an inner side;
b. a back enclosure defining a front edge and a rear edge, the back enclosure configured to be coupled to the face cover with the front edge adjacent the inner side of the face cover;
c. the face cover and the back enclosure together defining a receptacle depth from the inner side of the face cover to the rear edge of the back enclosure, wherein the receptacle depth is not greater than the limited depth;
d. a DC outlet and an AC outlet, each outlet accessible adjacent the outer side of the face cover;
e. an electrical connector for connecting to the AC power source and providing a connection to the AC outlet;
f. a DC power supply having an input connected to the AC power source and an output connected to the DC outlet.

2. The electrical receptacle according to claim 1, wherein the receptacle depth is not greater than 44.45-mm.

3. The electrical receptacle according to claim 1, wherein the receptacle depth is not greater than 42-mm.

4. The electrical receptacle according to claim 1, wherein the receptacle depth is not greater than 41.6-mm.

5. The electrical receptacle according to claim 1 wherein face cover and the back enclosure define an internal volume and wherein the electrical connector for connecting to the AC power source is within the internal volume.

6. The electrical receptacle according to claim 5 for use with the AC power source wherein the AC power source is provided via electrical wires wherein the electrical connector provides at least one quick-release fastener for connecting to the AC power source.

7. The electrical receptacle according to claim 6 wherein the back enclosure includes at least one hole allowing access to a control for the at least one quick-release fastener.

8. The electrical receptacle according to claim 1 wherein the back enclosure includes a bracket and a rear cover.

9. The electrical receptacle according to claim 8 wherein the bracket provides support for a printed circuit board providing at least a portion of the DC power supply.

10. An electrical receptacle for installation in a wall adjacent an area allowing only a depth for the electrical receptacle that is not greater than 44.45-mm, the electrical receptacle configured for connection to an AC power source, the electrical receptacle comprising:
a. a face cover defining an outer side and an inner side;
b. a back enclosure defining a front edge and a rear edge, the back enclosure configured to be coupled to the face cover with the front edge adjacent the inner side of the face cover;
c. the face cover and the back enclosure together defining a receptacle depth from the inner side of the face cover to the rear edge of the back enclosure, wherein the receptacle depth is not greater than 45-mm;
d. a DC outlet and an AC outlet, each outlet accessible adjacent the outer side of the face cover;
e. an electrical connector for connecting to the AC power source and providing a connection to the AC outlet;
f. a DC power supply having an input connected to the AC power source and an output connected to the DC outlet.

11. The electrical receptacle according to claim 10, wherein the receptacle depth is not greater than 42-mm.

12. The electrical receptacle according to claim 10, wherein the receptacle depth is not greater than 41.6-mm.

13. The electrical receptacle according to claim 10 wherein face cover and the back enclosure define an internal volume and wherein the electrical connector for connecting to the AC power source is within the internal volume.

14. The electrical receptacle according to claim 10 for use with the AC power source wherein the AC power source is provided via electrical wires wherein the electrical connector provides at least one quick-release fastener for connecting to the AC power source.

15. The electrical receptacle according to claim 14 wherein the back enclosure includes at least one hole allowing access to a control for the at least one quick-release fastener.

16. The electrical receptacle according to claim 10 wherein the back enclosure includes a bracket and a rear cover.

17. The electrical receptacle according to claim 16 wherein the bracket provides support for a printed circuit board providing at least a portion of the DC power supply.

18. An electrical receptacle for installation in a wall adjacent an area allowing only a limited depth for the electrical receptacle, wherein the limited depth may be defined by a typical depth of a construction for recreational vehicles, the electrical receptacle configured for connection to an AC power source, the electrical receptacle comprising:
a. a face cover defining an outer side and an inner side;
b. a back enclosure defining a front edge and a rear edge, the back enclosure configured to be coupled to the face cover with the front edge adjacent the inner side of the face cover;
c. the face cover and the back enclosure together defining a receptacle depth from the inner side of the face cover to the rear edge of the back enclosure, wherein the receptacle depth is not greater than the limited depth;
d. a DC outlet and an AC outlet, each outlet accessible adjacent the outer side of the face cover;
e. an electrical connector for connecting to the AC power source and providing a connection to the AC outlet, and wherein the face cover and the back enclosure define an internal volume and wherein the electrical connector for connecting to the AC power source is within the internal volume;
f. a DC power supply having an input connected to the AC power source and an output connected to the DC outlet.

19. The electrical receptacle according to claim 18, wherein the receptacle depth is not greater than 44.45-mm.

20. The electrical receptacle according to claim 18 for use with the AC power source wherein the AC power source is provided via electrical wires wherein the electrical connector provides at least one quick-release fastener for connecting to the AC power source.
